(19) United States
(12) Patent Application Publication
(10) Pub. No.: US 2019/0287120 A1
(43) Pub. Date: Sep. 19, 2019

(54) CONTENT MANAGEMENT OF DIGITAL RETAIL DISPLAYS

(71) Applicant: Target Brands, Inc., Minneapolis, MN (US)

(72) Inventors: Luis F. Galvez, Eden Prairie, MN (US); Tianwei Liu, Beijing (CN); Ivan Yakovenko, San Francisco, CA (US); Brijhette R. Farmer, Oakland, CA (US); Afsoon Nicknam, San Jose, CA (US); Sohei Okamoto, San Francisco, CA (US)

(21) Appl. No.: 16/357,623

(22) Filed: Mar. 19, 2019

Related U.S. Application Data
(60) Provisional application No. 62/644,649, filed on Mar. 19, 2018.

(51) Int. Cl. G06Q 30/02; G06F 3/14; G06K 9/00

(52) U.S. Cl. CPC G06Q 30/0201; G06F 3/1423; G06K 9/00771; G06K 9/00335; G06K 9/00255

(57) ABSTRACT

A networked system includes a plurality of devices that access user portals, a plurality of digital displays located in a retail store alongside retail or product displays and a real-time data store and processor. Each digital display displays content related to the retail or product displays, includes sensors and a camera and is configured to create user sessions with date and time stamps based on each camera detecting an anonymous customer's face. The processor is configured to analyze data collected from the sensors of each digital display during each user session to determine real-time in-store customer insight data related to in-store customer behavior and configured to relay the insight data to the user portals accessed by the plurality of devices.

### CROSS-REFERENCE TO RELATED APPLICATION

The present application is based on and claims the benefit of U.S. provisional patent application Ser. No. 62/644,649, filed Mar. 19, 2018, the contents of which are hereby incorporated by reference in their entireties.

### BACKGROUND

Interactive in-store digital displays integrate the familiar features of smart phones and tablets into in-store displays. Touchscreen surfaces take the form of wall installations or table displays and make it possible for customers to find out more information about a product or customize their experience with the product to make purchasing decisions easier.

The discussion above is merely provided for general background information and is not intended to be used as an aid in determining the scope of the claimed subject matter.

### SUMMARY

A networked system includes a plurality of devices that access user portals and a plurality of digital displays located in a retail store alongside retail or product displays. Each digital display displays content related to the retail or product displays, includes sensors and a camera and is configured to create user sessions with date and time stamps based on each camera detecting an anonymous customer's face. A real-time data store and processor is configured to analyze data collected from the sensors of each digital display during each user session to determine real-time in-store customer insight data related to in-store customer behavior and configured to relay the insight data to the user portals accessed by the plurality of devices.

A method of managing digital content in a retail store includes deploying digital content to digital displays positioned alongside retail or product displays in a retail store. Each digital display includes sensors and a camera and is configured to create user sessions with date and time stamps indicative of a customer interfacing with one of the digital displays and based on each camera detecting an anonymous customer's face. During each user session, data from the sensors and the cameras on the digital displays is collected and analyzed data from the sensors and the cameras located on the digital displays. Real-time in-store customer insight data is determined from the analyzed data and the insight data is sent to a plurality user portals accessible by a plurality of devices.

A method of managing digital content in a retail store includes receiving vendor digital content from a plurality of vendor devices and deploying the vendor digital content to digital displays positioned alongside retail or product displays in a retail store. Each digital display includes sensors and a camera and is configured to create user sessions with date and time stamps indicative of a customer interfacing with one of the digital displays. Data from the sensors and cameras located on the digital displays is collected and analyzed during each user session that relates to the retail or product displays. Real-time in-store customer insight data is determined from the analyzed data and the insight data is sent to the plurality of vendor devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic block diagram of a networked system including a content manager in communication with a plurality of devices according to an embodiment.

FIG. 2 is a detailed schematic block diagram of FIG. 1 according to an embodiment.

FIG. 3 is a flowchart of the content manager of FIGS. 1 and 2 validating login credentials according to an embodiment.

FIG. 4 is a flowchart illustrating an exemplary vendor user portal and its functionality according to an embodiment.

FIG. 5 is a flowchart illustrating the initiation of and ending of a guest or customer user session according to an embodiment.

FIG. 6 is an exemplary screenshot of content that is to be shown on an in-store digital display for a vendor retail product according to an embodiment, the vendor retail product being displayed alongside the in-store digital display.

FIG. 7 is an exemplary screenshot of content to be shown on the in-store digital display upon user selection that describes more detailed features of the vendor retail product according to an embodiment.

FIG. 8 is an exemplary screenshot of content that is to be shown on the in-store digital display upon user selection that shows reviews of the vendor retail product according to an embodiment.

FIG. 9 is an exemplary screenshot of video content that is to be shown on the in-store digital display upon user selection that describes the vendor retail product according to an embodiment.

FIG. 10 is an exemplary screenshot of content that is to be shown on the in-store digital display upon user selection that shows how other smart products work well with the vendor product or relate to the vendor retail product.

FIG. 11 is an exemplary screenshot of content that is to be shown on the in-store digital display upon user selection that allows the user to share information about the vendor retail product via email or text.

FIG. 12 is an exemplary screenshot of content that is to be shown on the in-store digital display upon user selection that shows that the user has “liked” the vendor retail product.

FIG. 13 is an exemplary screenshot of a vendor dashboard according to an embodiment.

FIG. 14 is a flowchart illustrating an exemplary buyer dashboard and its functionality according to an embodiment.

FIG. 15 illustrates an exemplary screenshot of an “at-a-glance” view of the buyer dashboard showing a summary of data according to an embodiment.

FIG. 16 illustrates another exemplary screenshot of a more detailed view of the buyer dashboard showing more information regarding summary data of traffic, engagement and sales according to an embodiment.

FIG. 17 is a flowchart illustrating an exemplary team member user portal and its functionality according to an embodiment.

FIG. 18 illustrates an exemplary screenshot of a store comment feed of the team member user portal according to an embodiment.

FIG. 19 illustrates an exemplary screenshot of a product listing page of the team member user portal according to an embodiment.

FIG. 20 illustrates an exemplary screenshot of a product detail page of the team member user portal according to embodiment.

FIG. 21 illustrates an exemplary screenshot of a comment submission form of the team member user portal according to an embodiment.

FIG. 22 provides a block diagram of a computing device that can be used in the various embodiments.

FIG. 23 is a block diagram of a mobile device that can be used in the various embodiments.

### DETAILED DESCRIPTION

The Internet of Things (IoT) is a network of physical devices or objects called smart devices that are embedded with electronics, software, sensors and connectivity for enabling the objects or smart devices to connect and exchange data. The IoT allows these objects or smart devices to be sensed or controlled remotely across the network so as to integrate the physical world into computer-based systems. Displaying IoT smart products, such as home related and connected home related devices, to customers in a retail setting is challenging. Oftentimes these products are not fully understood when relying on packaging design alone. Embodiments of a networked system are provided that engage guests or customers with in-store experiences at the ease and speed of online shopping experiences. In other words, the networked system includes in-store digital displays located in a retail environment that educate guests or customers more effectively through rich digital experiences or digital media content directed to product information to help the guests or customers make purchasing decisions. In addition, the in-store digital display is also capable of reporting traffic, engagement and activity to vendors, internal merchants or buyers who are selling products in the in-store retail setting and team members working in the store.

One problem with using an in-store digital display in a retail store, or other similar spaces, to educate guests or customers on products in a product display or information in a retail display is differentiating between the interactions of each guest or customer when the retail store does not want to require a user log-in or user-initiated application and merely wants to attract a customer to the information that is being displayed. To solve this problem, embodiments described below initiate a user session upon the in-store digital display detecting an anonymous customer's face and ending the user session upon the passing of a threshold of time since the in-store digital display last detected an anonymous customer's face. The content and activity that is navigated by the detected customers during each user session is tied to the user session.

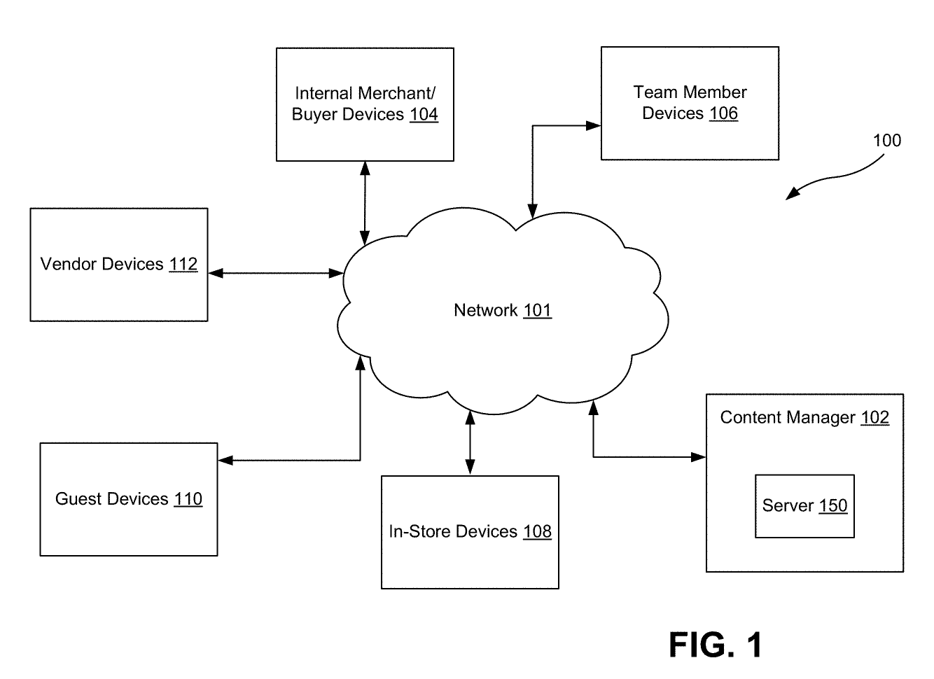

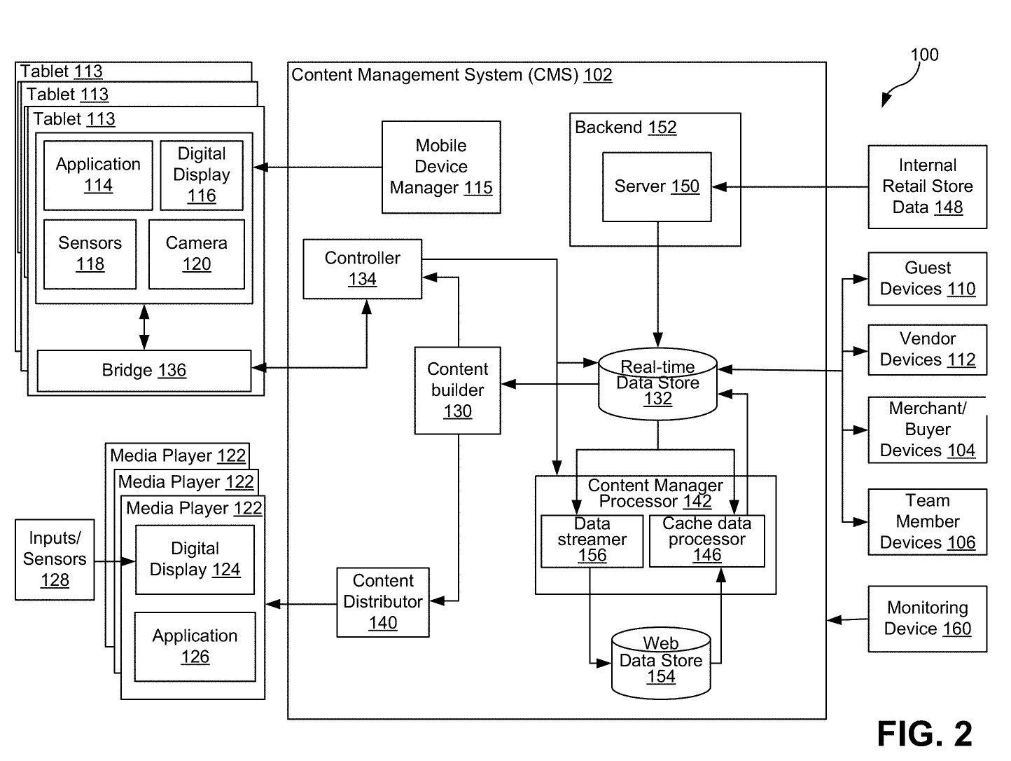

FIG. 1 is a schematic block diagram of a networked system 100 in communication with a plurality of modules according to an embodiment. Networked system 100 includes a network 101 in communication with a content manager 102 that has a server 150, internal merchant/buyer devices 104, team member devices 106, in-store devices 108, such as digital displays on tablets and media players that are displaying content regarding products on display, guest or customer devices 110 and vendor devices 112. FIG. 2 is a detailed schematic block diagram of FIG. 1 according to an embodiment. In the center of the FIG. 2 illustration is content manager 102 including a detailed block diagram of the components that make up content manager 102. On the right side of FIG. 2 are blocks representing some of the plurality of devices that are in communication with content manager 102 including merchant/buyer devices 104, team member devices 106, guest devices 110, vendor devices 112 and a monitoring device 160. Exemplary merchant/buyer devices 104, vendor devices 112 and monitoring device 160 include any type of computing device such as laptop computers, desktop computers, tablets or mobile devices that are capable of accessing or communicating with content manager 102 over a network, such as the Internet or an Intranet. Exemplary team member devices 106 include tablets or mobile computing devices that allow team members to carry the device while moving around a store floor, interacting with customers and recording gathered information. Exemplary guest devices 110 include guest or customer-owned mobile computing devices that the guest carries while shopping in the retail store, such as a mobile phone.

On the left side of the illustration are blocks representing in-store devices 108 (FIG. 1) that have digital displays, are in communication with content manager 102 and are used for displaying digital content to guests or customers in a retail store. Such devices 108 include tablet computers 113, where each tablet computer 113 may be equipped with at least an application 114 that is run by content manager 102 using a mobile device manager 115, a digital display 116, sensors 118 and a camera 120. In particular, each tablet computer 112 is placed in the retail store alongside the retail product being described or sold. Sensors 118 and camera 120 sense customer behavior. Exemplary sensors 118 include touch sensors on digital display 116, which act as a touchpad for tablet computer 112 and IR sensors. Camera 120 captures data related to customers passing by and also data related to a customer stopping at the product or dwelling at the product on display. In one embodiment, camera 120 collects data to be processed by facial detection software to determine the presence of an anonymous customer's face. An IR sensor may also detect a person entering and leaving the product display by the person blocking and unblocking the IR sensor. No matter, if passing or dwell time is sensed by sensors 118 or camera 120, that event information initiates a user session with a date and time stamp and duration and is pushed to real-time data store 132.

Content manager 102 controls the content on digital displays 116 of in-store tablets 112 and on digital displays 124 of in-store media players 122. Content manager 102 builds the digital content stored in real-time data store 132 using content builder 130. Controller 134 of content manager 102 feeds the content in the form of commands to a bridge 136 in each of tablets 112 and ultimately displays the content built with content builder 130 on each of the digital displays 116 of tablets 112 with the content for the particular vendor product that each tablet 112 is located alongside.

Another type of device for displaying digital content to guests or customers in a retail store are media players 122, which may be static digital screens. Media players 122 engage guests and customers visually, but are not necessarily interactive as are tablet computers 112 as is shown in FIG. 2. Each media player 122 may be equipped with a digital display 124 and an application 126 and may receive inputs from inputs and/or sensors 128. Exemplary inputs include buttons or physical representations or implementations of GUI widgets. While not specifically shown, inputs may include a camera that may detect viewers, but generally these inputs or sensors 128 are used only to wake media players 122 up and not for collecting insight data. Content manager 140 provides templates and content packages to digital displays 124 and applications 126 on media players 122 to ultimately display the content built with content builder 130 on displays 124.

Monitoring device 160 is configured to initially set up tablets 112 and facilitate tablets 112 coming in line with content manager 102. After set up, monitoring device 160 ensures that tablets 112 remain in-line, are running with appropriate content and monitor health of the overall networked system. In other words, monitoring device 160 is coupled to controller 134, backend 152, real-time data store 132, content manager processor 142 and content builder 130.

Content manager 102 is not only configured to obtain product information and digital content that is to be displayed on displays 116 and 124 of tablets 112 and media players 122 from vendors, but content manager 102 is also configured to analyze the behavioral data obtained in user sessions by tablets 112 and team member devices 106 and then in turn reporting the behavioral data to vendors devices 102, merchant/buyer devices 104, team member devices 106 and guest devices 110.

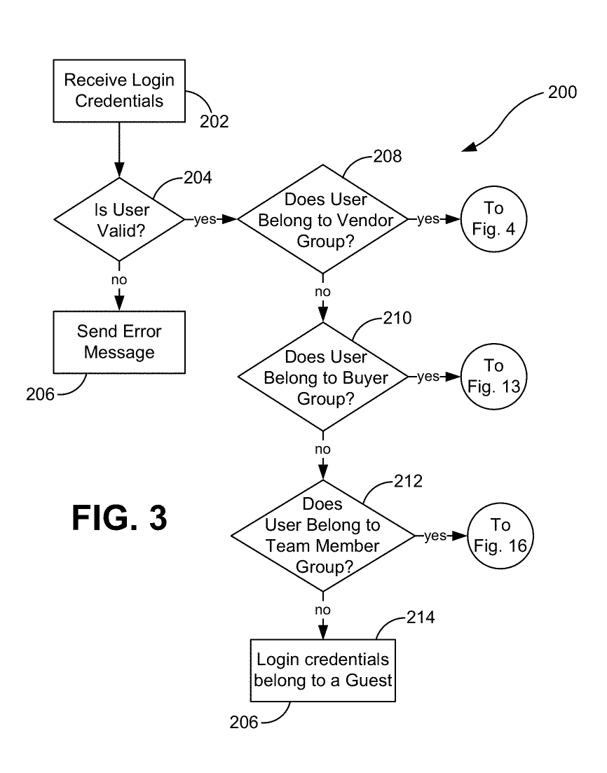

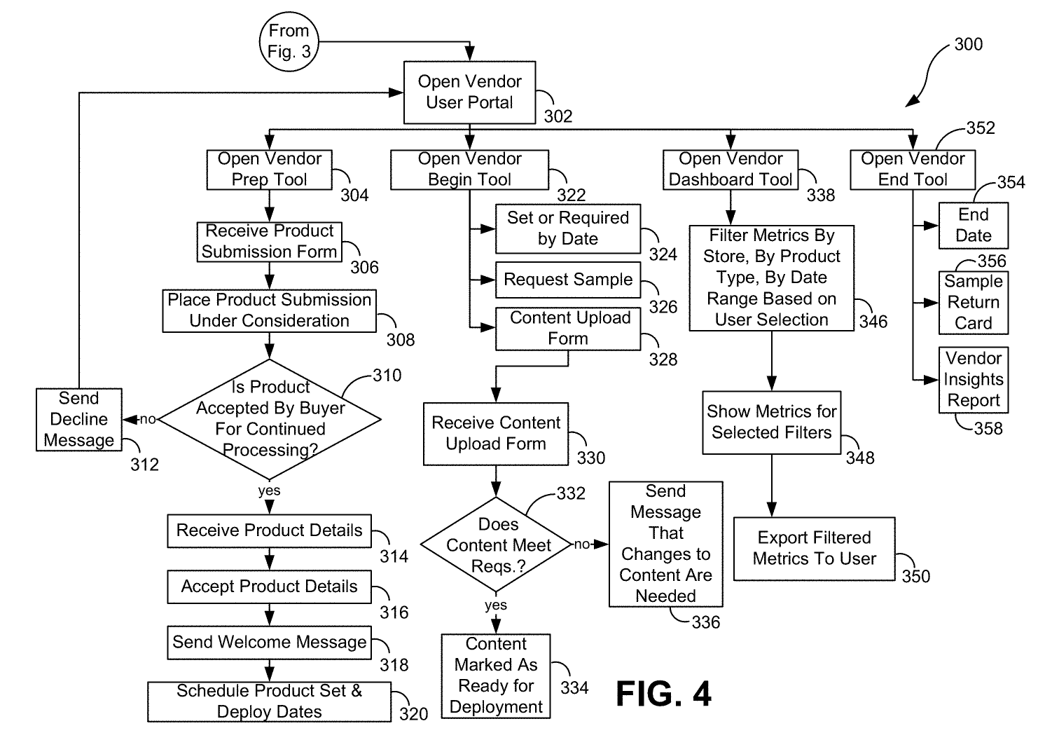

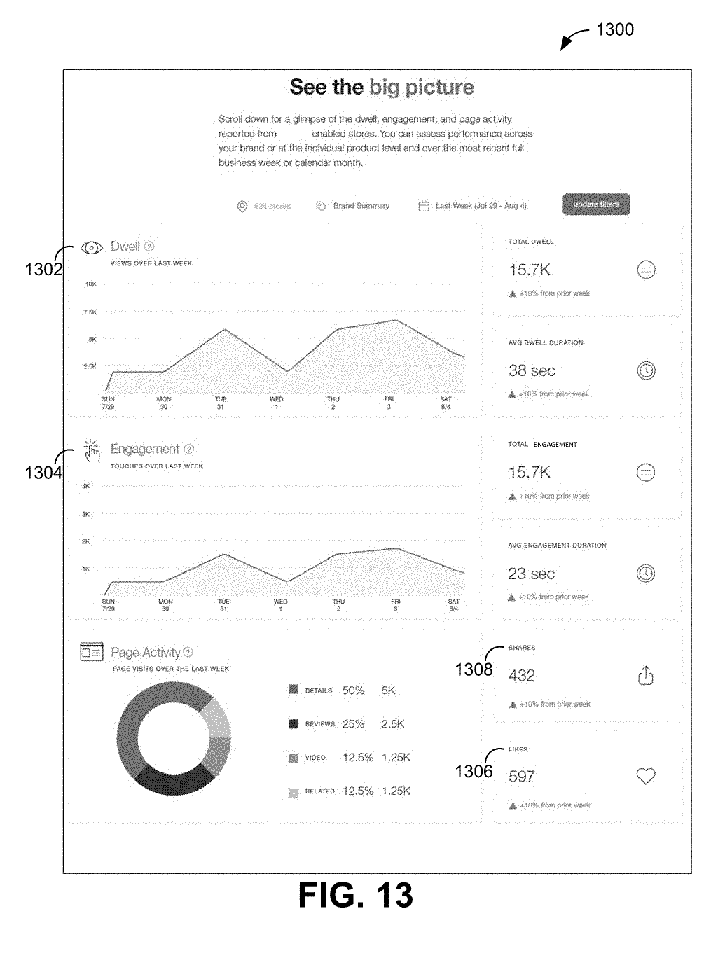

FIG. 3 is a flowchart 200 illustrating the validation of login credentials of a user of a vendor device 102, merchant/buyer device 104, a team member device 106 or a guest device 110 by content manager 102. At block 202, content manager 102 receives login credentials from a user. At block 204, it is determined whether the login credentials are valid. If the login credentials are invalid, content manager 102 sends an error message at block 20. If the login credentials are valid, content manager 102 passes to block 208 and determines whether the login credentials belong to a vendor group. If the login credentials belong to a vendor user, content manager 102 passes to FIG. 4 to open a vendor portal for the vendor user. If not, content manager 102 passes to block 210 to determine if the login credentials belong to a buyer group. If the login credentials belong to a buyer user, content manager 102 passes to FIG. 13 to open a merchant/buyer dashboard for the buyer user. If not, content manager 102 passes to block 212 to determine if the login credentials belong to a team member group. If the login credentials belong to a team member user, content manager 102 passes to FIG. 16 to open a team member portal for the team member user. If not, content manager 102 passes to block 214 where the credentials are found to belong to a guest or customer.

FIG. 4 is a flowchart 300 illustrating interactions with an exemplary vendor user portal and the functionality of that user portal according to an embodiment. At block 302, a vendor device accesses the vendor user portal. Within the vendor user portal are the tools the vendor user may use to guide them along an end-to-end process from creating an account to uploading their content to an online dashboard where the vendor user can see analytics on how their products are performing and what guests are saying about them in stores. In particular, under one embodiment and after vendor user portal is accessed at block 302, the vendor user accesses and opens a vendor prep tool at block 304 that allows the vendor to submit their product for consideration. Under the vendor prep tool, a submissions form is presented to the vendor user where the vendor user fills in information pertaining to date, name of product being submitted, URL of the product being submitted, a description and vendor contact information. Within the form, information is included that relates to what kinds of products are currently being accepted, what kinds of products are deemed unsuitable and what types of products could go either way.

At block 306, content manager 102 receives the product submission form that was filled out by the vendor user, and at block 308, content manager 102 places the product submission under consideration. In FIG. 2, this type of received information is stored in real-time data store 132 upon submission. The product submissions are then sent to merchant/buyer devices 104 for consideration. Consideration factors include category needs, value proposition, benefits, key learnings and reviews of the product. At block 310, it is determined whether the product submitted by the vendor user was accepted by the buyer group for continued processing. If not, content manager 102 passes to block 312 and sends a decline message to the vendor user. If accepted, content manager 102 passes to block 314 and asks for and receives further product details. Exemplary further product details include timing, location, status, pricing, tags and contact information. Content manager 102 then accepts the product details at block 316 and sends a welcome message to the vendor user at block 318. Further, content manager 102 in conjunction with the buyer group schedules the product set and deploy dates of the vendor product.

Under another embodiment and after the vendor user portal is accessed at block 302, the vendor user opens a vendor begin tool at block 322 that allows the vendor to access and see the set by date or required by date as shown in block 324, a sample request as shown in block 326, and a content upload form and tutorial as shown in block 328. The set by date or required by date is provided by the buyer group. The vendor user may respond to the sample request by confirming that the sample will be delivered or shipped along with the estimated date of arrival. The vendor user may then upload content related to their product or smart product. The content tutorial is a comprehensive list of acceptable and unacceptable content and the vendor is encouraged to prepare content prior to upload. At block 330, the user fills out and content manager 102 receives a content upload form. At block 332, it is determined whether the digital content uploaded by the vendor meets requirements. In FIG. 2, this type of received information is referred to as contents and is stored in real-time data store 132 upon upload. If the digital content meets requirements, then content manager 102 passes to block 334 and marks the content as ready for deployment to a tablet 112 (FIG. 3) or media player 122 (FIG. 3) located in store. If the content does not meet requirements, then content manager 102 passes to block 336 and sends a message to the vendor outlining updates or changes that are needed to the content and asks the vendor user to revise and resubmit. The digital content stored in real-time data store 132 is ultimately fed to content builder 130 and controller 134 or content manager 140 for display on tablets 112 and media players 122 as illustrated in FIG. 2. As a result, vendor digital content is seamlessly deployed from content manager 102 (a single source) to a plurality of remote in-store tablets 112 across multiple stores and also a plurality of team member devices 106 through networked system 100.

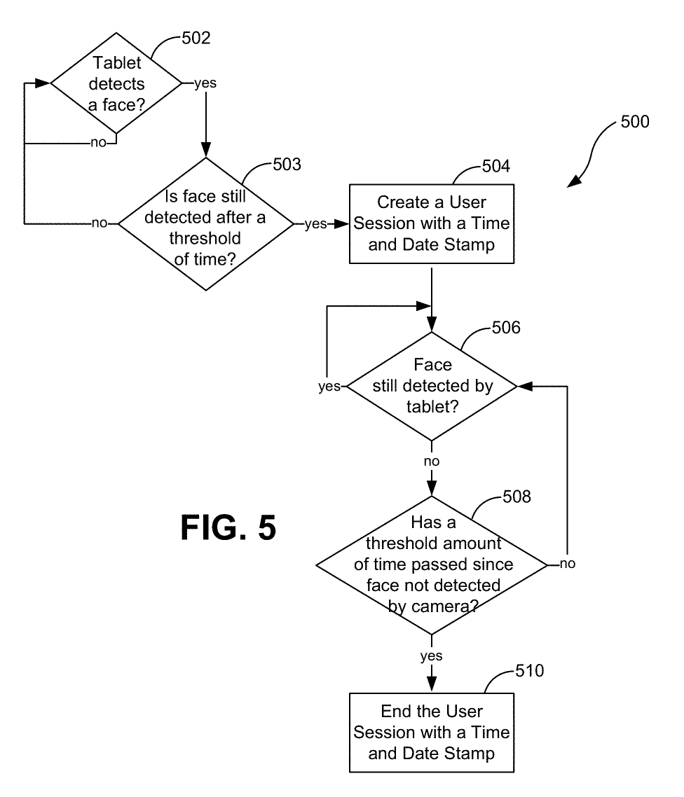

FIG. 5 is a flowchart 500 illustrating the initiation of and ending of a guest or customer user session according to an embodiment. At block 502, application 114 determines if camera 120 has detected an anonymous person's face. If not, flowchart 500 loops through this determination until application 114 determines that camera 120 has indeed detected a face. Upon capturing of a face, flowchart 500 proceeds to block 503 where application 114 determines if the face is still detected after a threshold period of time. If not, flowchart 500 loops back to block 502. If so, flowchart proceeds to block 504 and application 114 creates a user session with a time and date stamp. At block 506, application 114 determines whether a face is still being detected by camera 120. If so, flowchart 500 loops through this determination until application 114 determines that camera 120 is no longer detecting a face.

When camera 120 is no longer detecting a face, it could mean one of two things. The person has briefly looked away from digital display 116 on tablet 112 or the customer has left. To make the determination between both instances, at block 508, it is determined if a threshold amount of time has passed since a face was detected. If not, flowchart 500 loops back to block 506 to determine if a face is again being detected by camera 120. If a face is again being detected, this means that the customer had briefly looked away and is looking at digital display 116 again and the user session is still valid. If the threshold amount of time has expired, flowchart 500 passes to block 510 to end the user session with a time and date stamp. that is saved in real-time data store 132. This means that the person has left and the session ends. The digital content that is being sent to tablet 112 during a user session as well as the different interactions of the user engaging with tablet 112 during a user session are tied to the user session created and are recorded. Data gathered during the user session, such as traffic, engagement and activity will be relayed to vendors, internal merchants or buyers who are selling products in the in-store retail setting and team members working in the store. It should be realized that in some instances, touches and swipes have been sensed on tablet 112, but no face detection. In this example and based on the timing of those touches, user sessions may be adjusted to capture those interactions. In addition, thresholds and settings may also be adjusted to become more or less sensitive to customers that are passing by the tablet 112 versus a dwelling customer that stops at tablet 112.

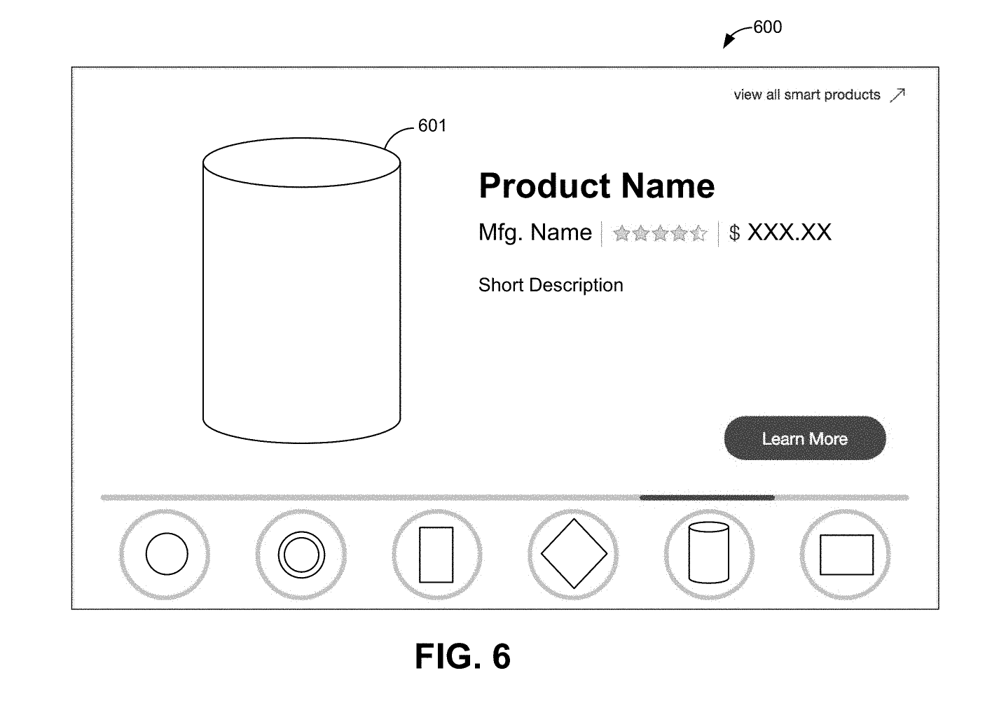

FIG. 6 illustrates an exemplary screenshot 600 of digital content that is to be shown on a tablet 112 for a vendor product 601 that is displayed in a retail environment alongside tablet 112. In this user interface, the product name, the product manufacturer, the price, a summary of reviews and basic product information in a short description is supplied for the vendor product 601. If a dwelling guest or customer, to whom a user session has been initiated upon capturing a user's face, wants to find out more information they may begin engaging with tablet 112 to explore more content, such as by touching the touch screen or touchpad, making selections, etc. For example, a user may touch the “Learn More” button illustrated in FIG. 6.

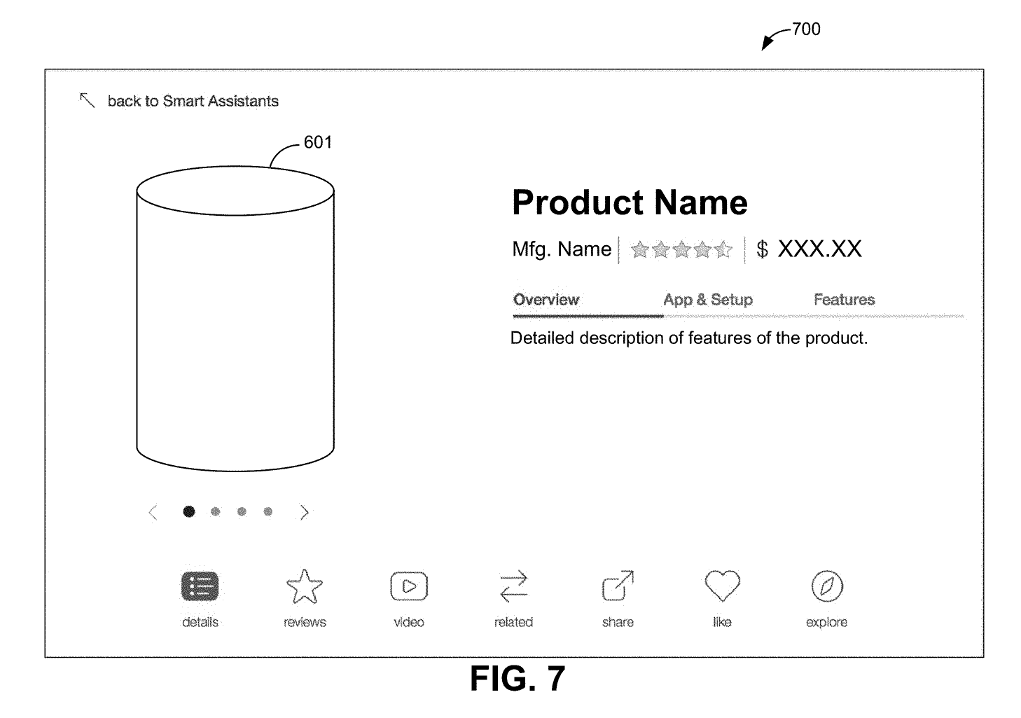

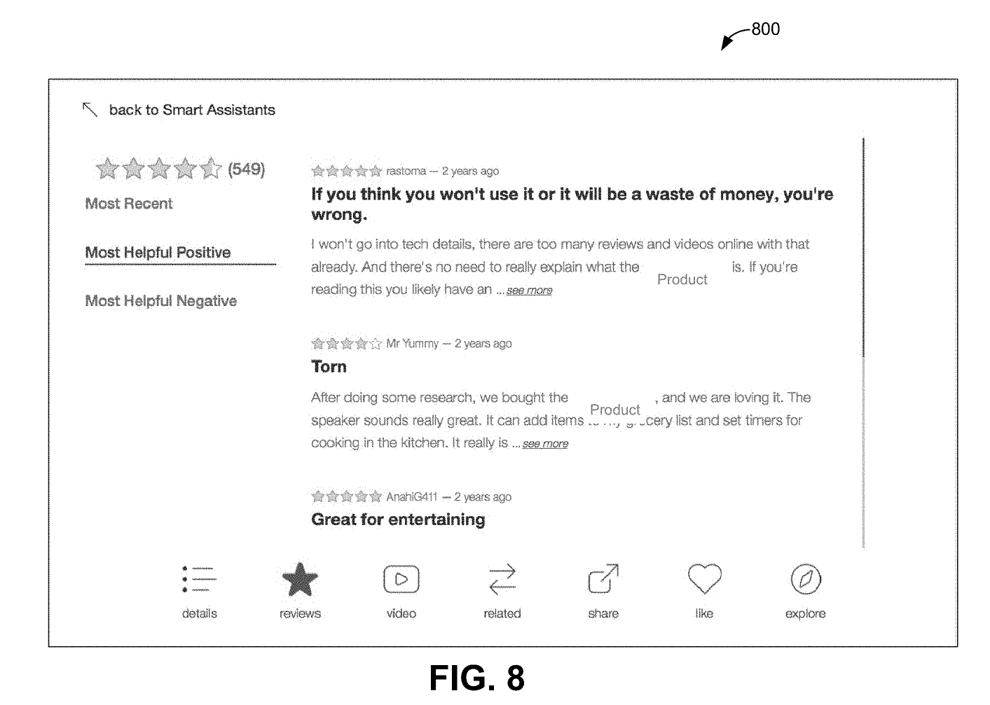

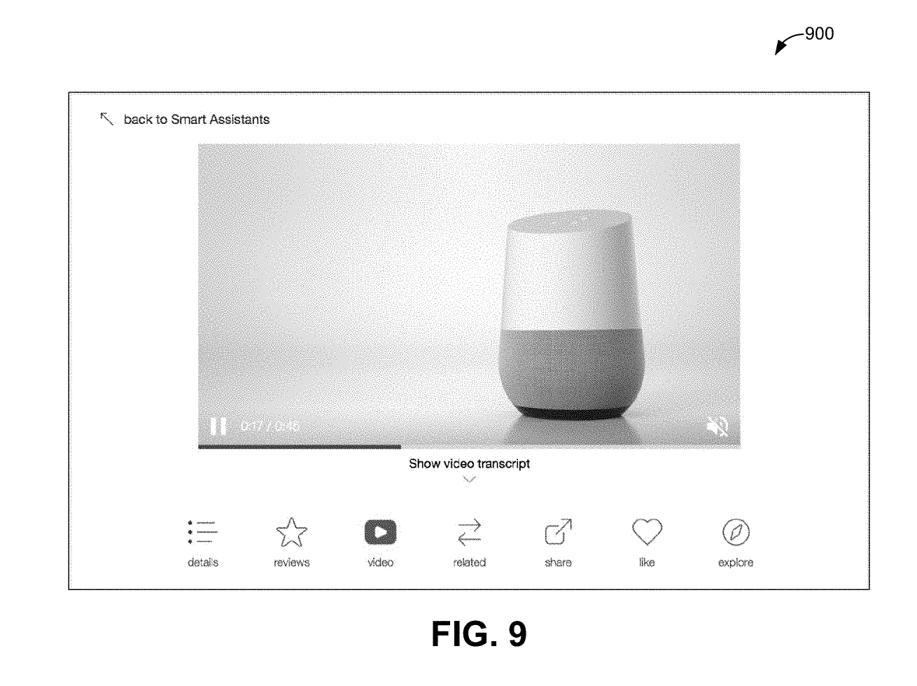

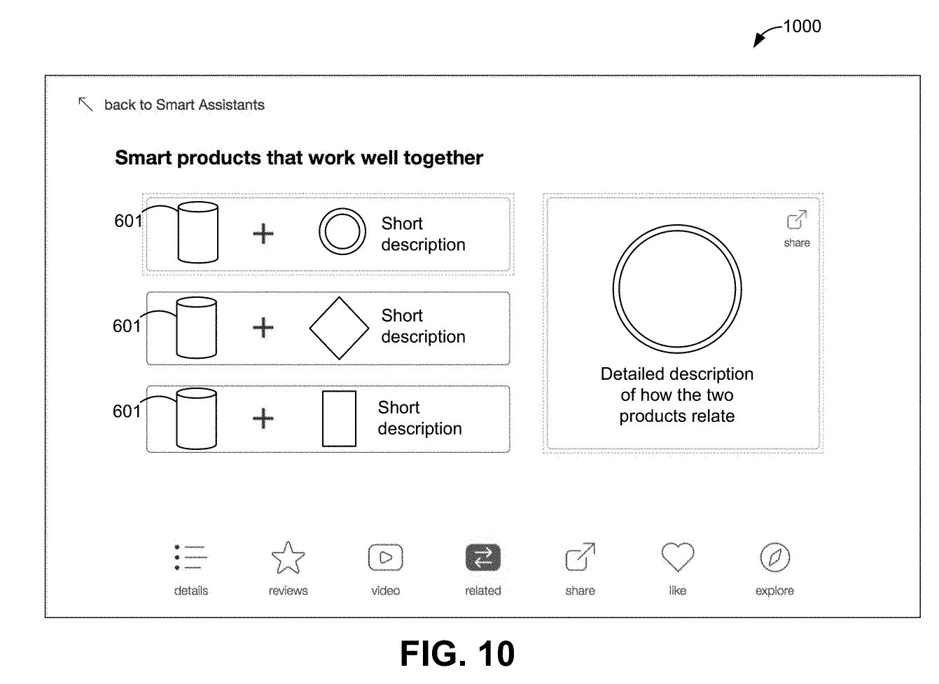

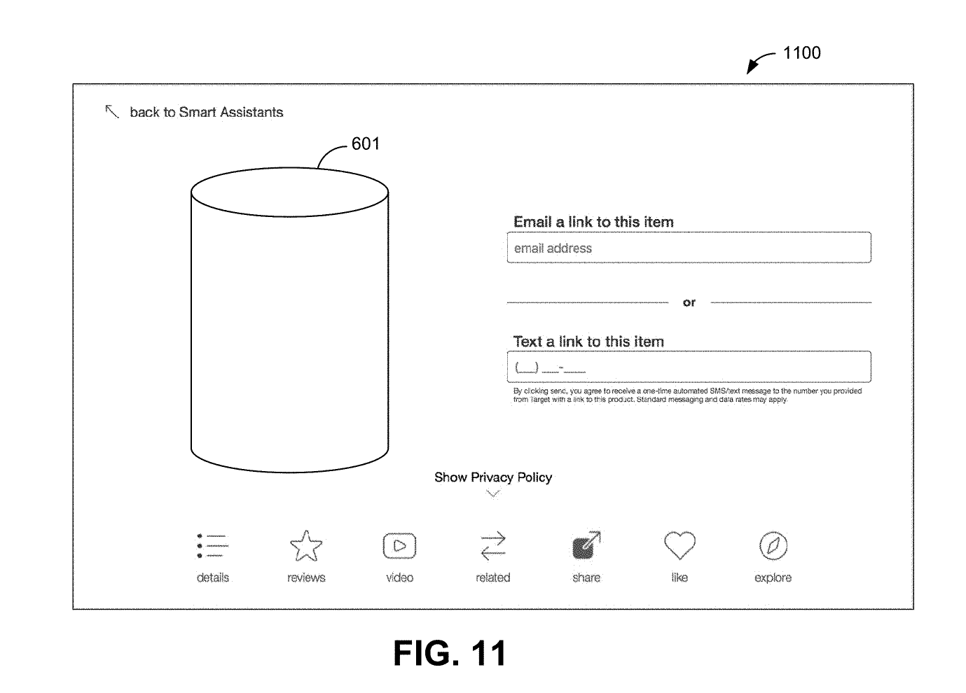

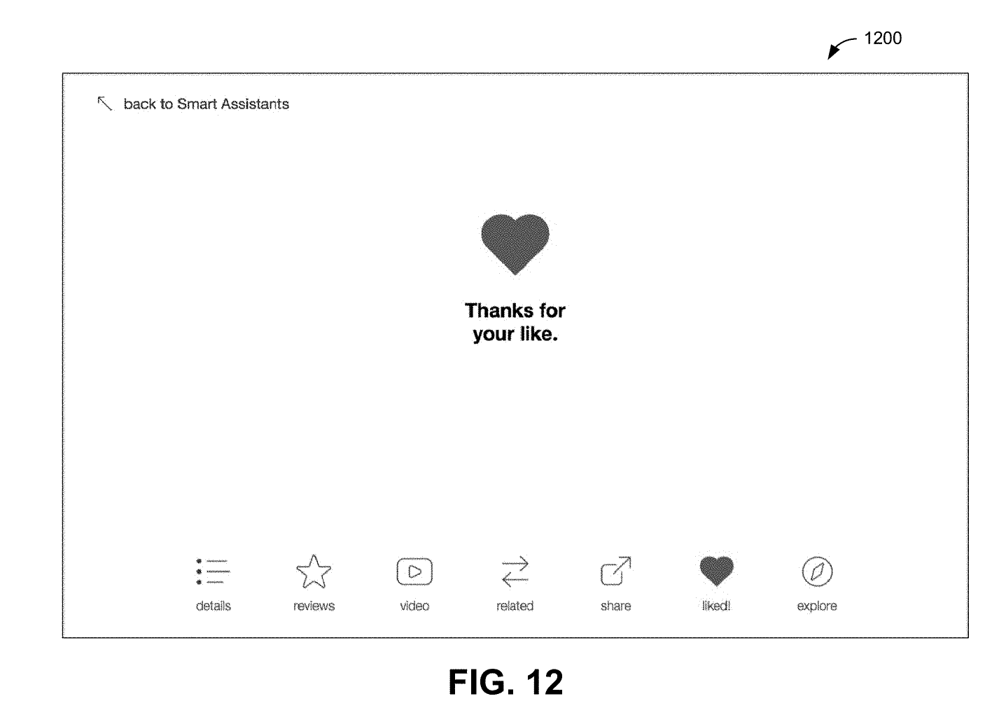

FIG. 7 is an exemplary screenshot 700 of content to be shown on in-store tablet 112 upon user selection that describes more detailed features of vendor product 601 according to an embodiment. In this example and as shown, an overview of the product is given by way of a detailed description and the user can further select information related to the associated App with the vendor product and features of the vendor product. FIG. 8 is an exemplary screenshot 800 of content that is to be shown on in-store tablet 112 upon user selection that shows reviews of vendor product 601 according to an embodiment. FIG. 9 is an exemplary screenshot 900 of video content that is to be shown on in-store tablet 112 upon user selection that describes vendor product 601 according to an embodiment. FIG. 10 is an exemplary screenshot 1000 of content that is to be shown on in-store tablet 112 upon user selection that shows how other smart products work well with vendor product 601 or relate to vendor product 601. FIG. 11 is an exemplary screenshot 1100 of content that is to be shown on in-store tablet 112 upon user selection that allows the user to share information about vendor product 601 via email or text. FIG. 12 is an exemplary screenshot 1200 of content that is to be shown on in-store tablet 112 upon user selection that shows that the user has “liked” vendor product 601.

Under yet another embodiment and after the vendor portal is opened at block 302 of FIG. 4, the vendor user accesses and content manager 102 opens a vendor dashboard tool at block 338. Vendor dashboard 344 provides insights related to the vendor user's product by showing to the vendor user information related to guest or customer traffic, engagement and sales. These insights are automatically updated in real-time. Using the insights, the vendor user may change the digital content that was uploaded to better attract the attention of or inform the guests or customers that are passing by, dwelling or interacting by touching tablet 112.

FIG. 13 illustrates an exemplary screenshot 1300 of a vendor dashboard. As shown in block 346, content manager 102 may apply a filter as directed by the vendor user through the vendor dashboard. The vendor user may filter the insights or metrics collated on the vendor dashboard by store, by brand, by individual product and by date range based on the vendor user selection. As illustrated in FIG. 13, a brand and date range filter is applied and the resulting insights or metrics are illustrated.

In the vendor dashboard, a “saw it” field or dwell field 1302 includes a raw count of all user sessions detected by sensors 118 or cameras 120 no matter the duration determined by a time stamp. In FIG. 13, this metric shows the number of impressions or views that the brand received by user sessions or customers in the store. In other words, this event data relates to the number of guests or customers that were tracked passing by or viewing the in-store tablet(s) 112. To produce these impressions or views, user sessions are fed to cache data processor 146 (FIG. 2), which determines a count of guests or customers that are walking past or viewing tablet 112 and saves that count in web data store 154.

In addition, dwell field 1302 may also include the number of user sessions or customers who were curious enough about the product to stop at the in-store tablet 112 located alongside the product as determined by content manager 102. To produce these stops or dwells, user sessions are fed to content manager processor 142 (FIG. 2), which determines a count of guests or customers that stop at the product for a threshold amount of seconds and saves that count in web data store 154 and may or may not add that count to dwell field 1302.

In the vendor dashboard, a “touched it” field or engagement field 1306 illustrates the number of user sessions or customers that engaged with or interacted with the in-store tablet 112 as determined by content manager 102 in combination with, for example, sensors 118, and includes any taps and swipes. These actions may be the customer switching views, tapping the like button, sending an email and etc. Sensor data from sensors 118 is fed to content manager processor 142 as event data through controller 134, real-time data store 132, data streamer 156 of content manager processor 142 and finally saved in web data store 154. In other words, content manager 102 tracks a count of user sessions or customers who touch the in-store tablet that is displaying information about the product and saves that count in web data store 154.

A “bought it” field (not illustrated in FIG. 13) includes the number of units of product sold by the store or stores selected in the filter. In other words, content manager 102 accesses internal retail store data 148 through a server 150 on the backend 152 to determine how many units of product were sold. Purchasing data is also called event data and is saved in web data store 154. Still further, content manager 102 tracks a count of user sessions or customers who tapped the heart or other type of icon to indicate their like of the vendor product. “Liked it” data field 1306 is event data that is saved in web data store 154. Content manager 102 also tracks and stores shares made by guests or customers and team members regarding the vendor product. In this embodiment, share field 1208 is event data that is saved in web data store 154. Other data that is tracked and saved in web data store 154 includes comments made by guests or customers and team members regarding the vendor product. In this embodiment, comments may be curated by team members by recording what guests are saying or making their own comments about the vendor product.

Under yet another embodiment and after the vendor user portal is opened at block 302 in FIG. 4, the vendor user accesses and content manager 102 opens a vendor end tool at block 352 that allows the vendor user to access and see an end date of vendor product deployment as shown in block 354, a sample return card as shown in block 356 and a vendor insights report as shown in block 358. An end date at block 352 originates from the buyer user, the vendor user sees data on when the sample will be shipped back and has the option to pick it up at block 354 and the insights report will include at least the data that was located on vendor dashboard 344 and may be printed or sent to the vendor via email.

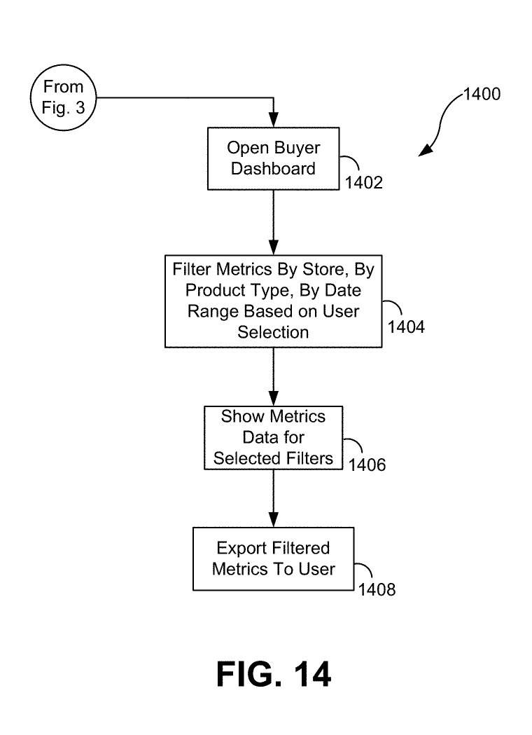

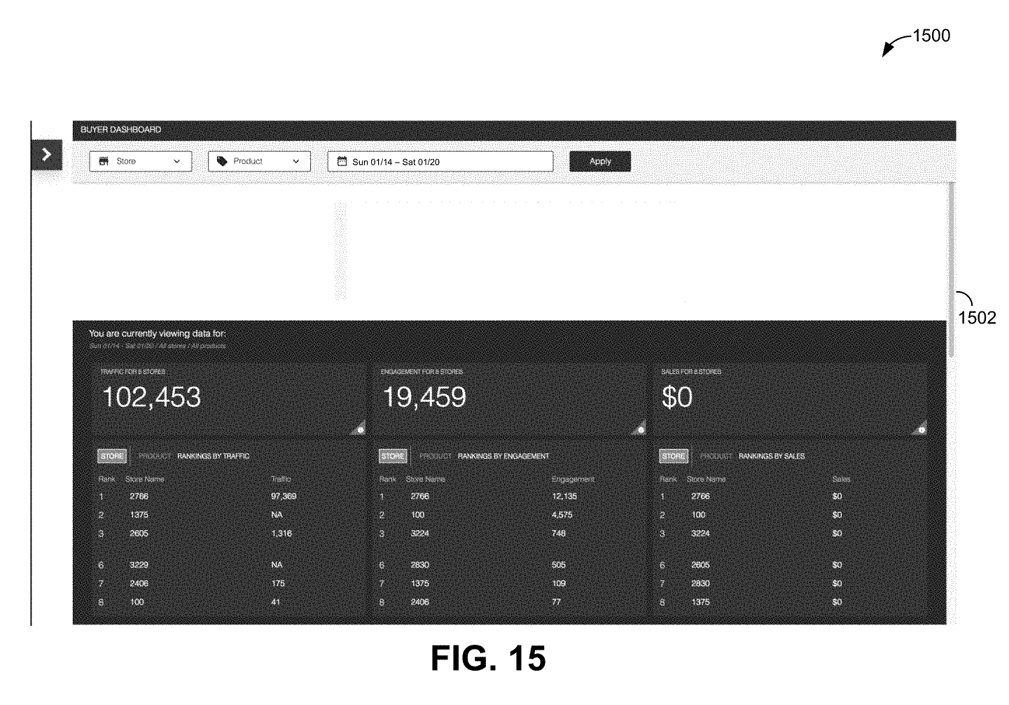

FIG. 14 is a flowchart 1400 illustrating interactions with an exemplary buyer dashboard and the functionality of that dashboard according to an embodiment. At block 1402, the buyer dashboard is accessed by a buyer user. Within the buyer dashboard are the tools the buyer user may use to view, filter, export and download insights or metrics related to vendor products by showing to the buyer user information related to guest or customer traffic, engagement and sales. These insights or metrics are automatically updated in real-time. FIG. 15 illustrates an exemplary screenshot 1500 of an “at-a-glance” view of buyer dashboard 1502 showing a summary of data according to an embodiment. As shown in block 1404 of flowchart 1400, content manager 102 may apply a filter insights or metrics as directed by the buyer user through buyer dashboard 1502. The buyer user may filter the insights or metrics collated on buyer dashboard 1502 by store, by product type and by date range based on the buyer user selection.

As illustrated in FIG. 15, such filters are applied and the resulting insights or metrics are shown as described in block 1406 of flowchart 1400. For example, the buyer user may select individual stores or “All Stores,” which is illustrated in FIG. 15. The buyer user may select individual products or “All Products,” which is illustrated in FIG. 15. The buyer user may select presets of data ranges or their own date range. In FIG. 15, a particular date range of a week was selected. FIG. 16 illustrates another exemplary screenshot 1600 of a more detailed view of buyer dashboard 1502 showing more information regarding summary data of traffic, engagement and sales according to an embodiment. At block 1408 in FIG. 14, the filtered metrics in block 1406 may be exported to the buyer user.

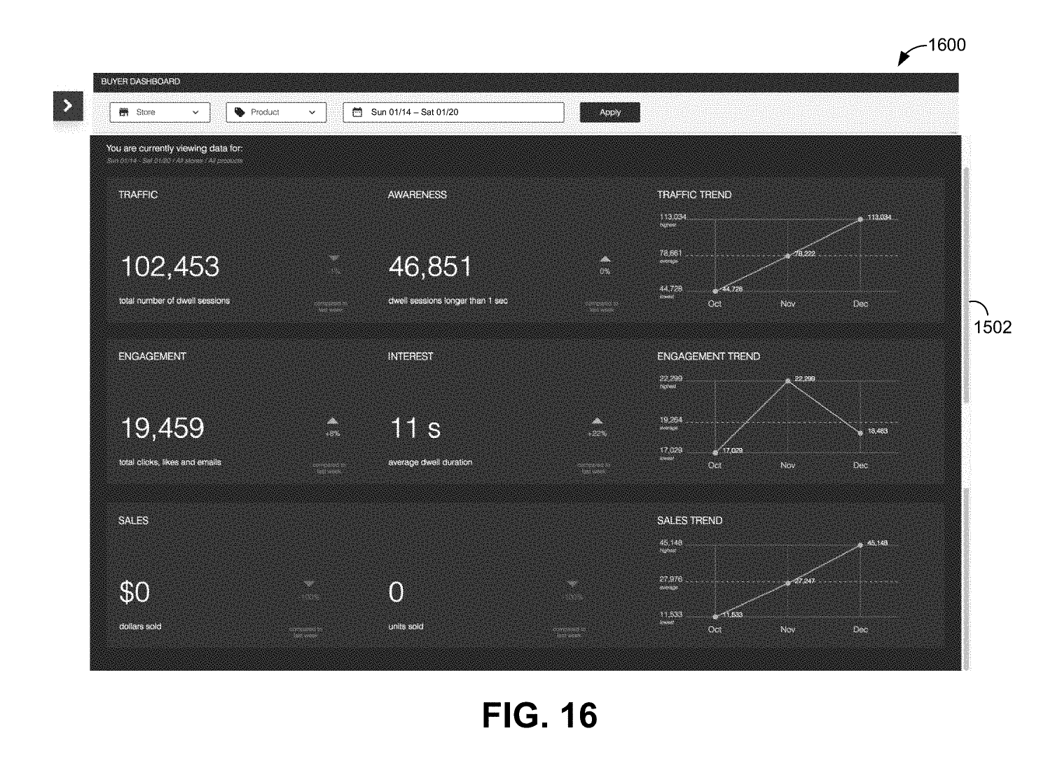

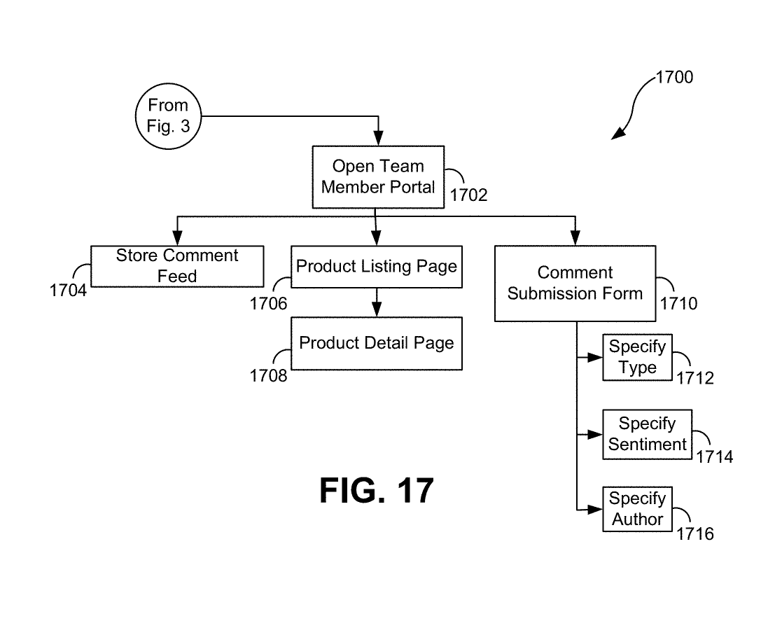

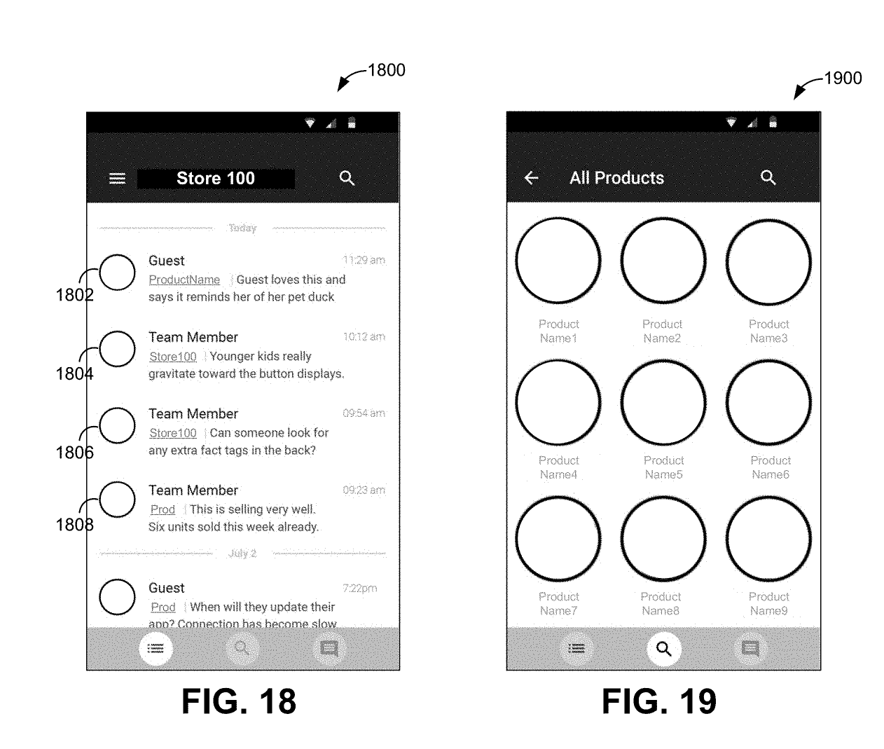

FIG. 17 is a flowchart 1700 illustrating an exemplary team member user portal for content manager 102 and the functionality of that user portal according to an embodiment. At block 1702, the team member user portal is accessed. Within team member user portal are the tools the team member may use to learn and reference the most up-to-date information about products that are currently in the assortment, view product metrics, product details and may leave comments and view comments already left based on interaction with guests or customers. At block 1704, the team member user sees a store comment feed. The store comment feed includes a table of metrics by product and by store with an explanation of each. Columns in the store comment feed may be made viewable or hidden. FIG. 18 illustrates an exemplary screenshot 1800 of the store comment feed according to an embodiment. In FIG. 18, real-time notifications and comments are made about various products 1802 and 1808 being sold in a particular store as well as team member requests and interesting information 1804 and 1806.

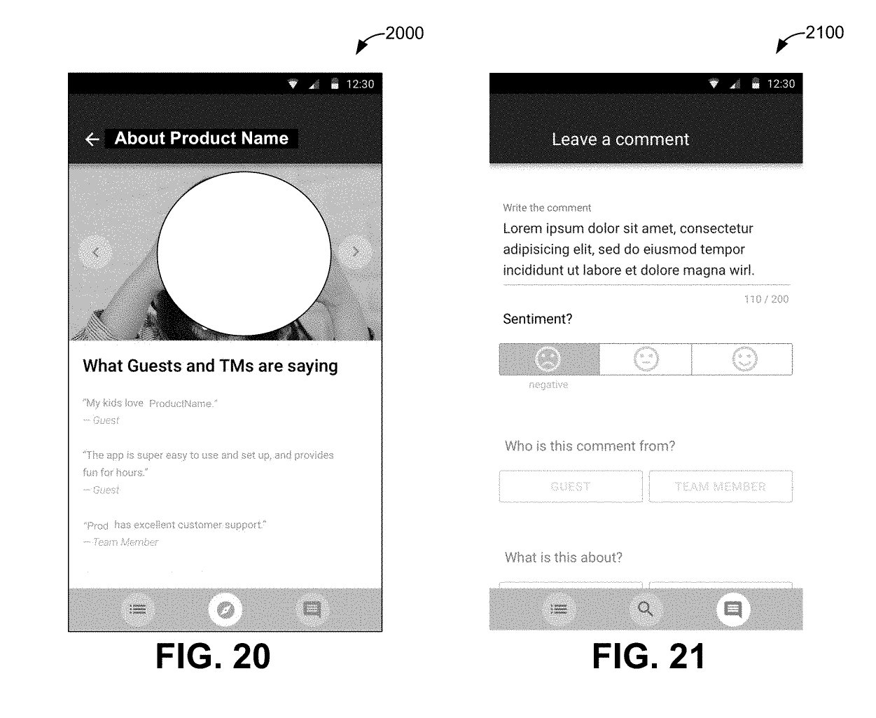

At blocks 1706 and 1708, the team member user sees a product listing page and a product detail page, respectively. The product listing page includes a summary list of products within the store where the team member is located and the product detail page includes highlighted images, frequently asked questions and comments. FIG. 19 illustrates an exemplary screenshot 1900 of the product listing page and FIG. 20 illustrates an exemplary screenshot 2000 of the product detail page according to embodiments. At block 1710, the team member user sees a comment submission form. Here, the team member user may leave comments about the product that are from the guest or customer or from the team member user. The comments also include a sentiment (e.g., negative, neutral, positive) as well as the ability for the team member user to leave hashtags. FIG. 21 illustrates an exemplary screenshot 2100 of the comment submission form according to an embodiment. At blocks 1712, 1714 and 1716, content manager 102 receives product comments from the team member user and stores or saves the comments.

With reference back to the types of content shown on digital displays of in-store tablet 112, FIG. 8 illustrates exemplary screenshot 800 of a user interface of reviews. These comments may be comments imported by a team member user through the comment submission form and are displayed to guests and customers who are interacting with or engaging with in-store tablet 112. FIG. 11 illustrates exemplary screenshot 1100 of a submission form for the guest or customer to import their email address or their phone number for receiving a text message so that a web link may be sent to the guest or customer so that they may explore information about the product 601 in more detail on their own or at another time. In other words, the guests or customers have the ability to continue their shopping experience at home.

A/B testing is a tool or method of comparing two versions of digital media content against each other to determine which one performs better. Such A/B testing is simple to perform on websites where two versions of a webpage are shown to users at random, and statistical analysis is used to determine which variation performed better for a conversion goal. Networked system 100 is an environment where A/B testing can be performed in a brick and mortar retail store chain setting where different versions of digital media content are shown on digital displays next to retail or product displays. The A/B testing can optimize based on different stores in the chain and their store locations, different times of day and different business or seasonal cycles. Insight data can be analyzed for the A/B testing at an impression level (e.g., how many customers stopped at certain digital media content), at an engagement level (e.g., how many customers interacted with the digital media content) and at an activity level (e.g., which screens or interfaces of digital media content was viewed).

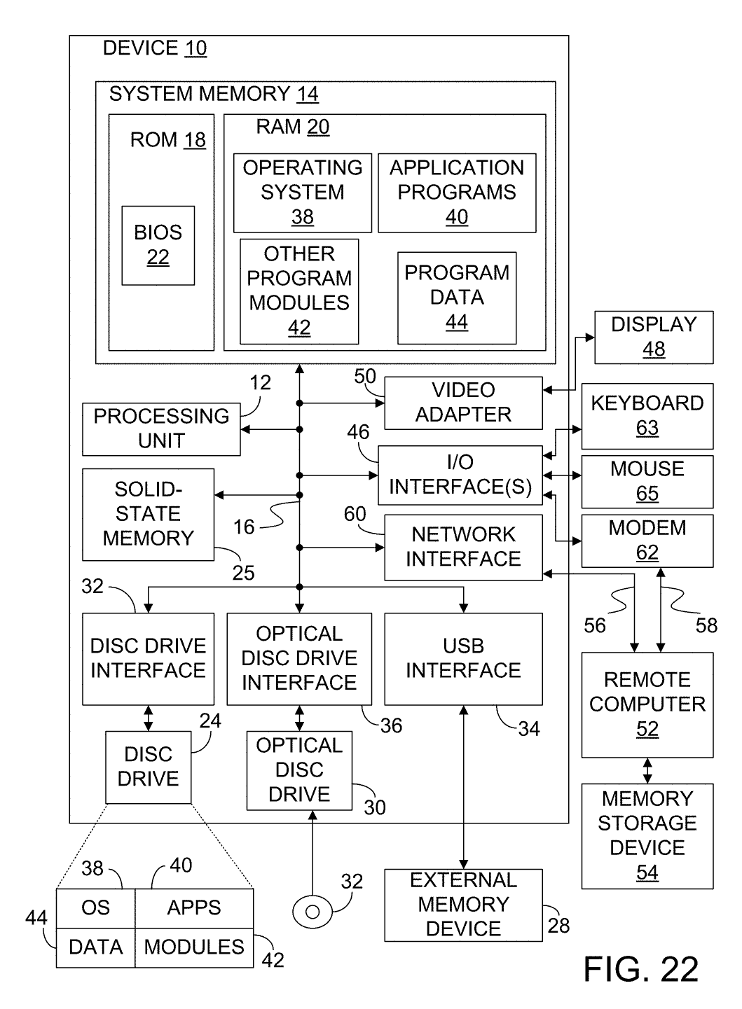

FIG. 22 provides an example of a computing device 10 that can be used as a vendor device, a buyer device, a team member device, an in-store device, a guest device, a server device or a tablet in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 may further include a hard disc drive 24 or other type of flash memory device, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. Processing unit 12, also referred to as a processor, executes programs in system memory 14 and solid state memory 25 to perform the methods described above.

Input devices may include a keyboard 63 and a mouse 65 are connected to system bus 16 through an Input/Output interface 46 that is coupled to system bus 16. Display 48 is connected to the system bus 16 through a video adapter 50 and provides graphical images to users. Other peripheral output devices (e.g., sensor or cameras) could also be included but have not been illustrated. In accordance with some embodiments, display 48 comprises a touch screen that both displays input and provides locations on the screen where the user is contacting the screen.

The computing device 10 may operate in a network environment as illustrated in the above embodiments, utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 21. The network connections depicted in FIG. 22 include a local area network (LAN) 56 and a wide area network (WAN) 58. Such network environments are commonplace in the art.

The computing device 10 may be connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIGS. 1 and 2 are exemplary and other means for establishing a communications link between the computers, such as a wireless interface communications link, may be used.

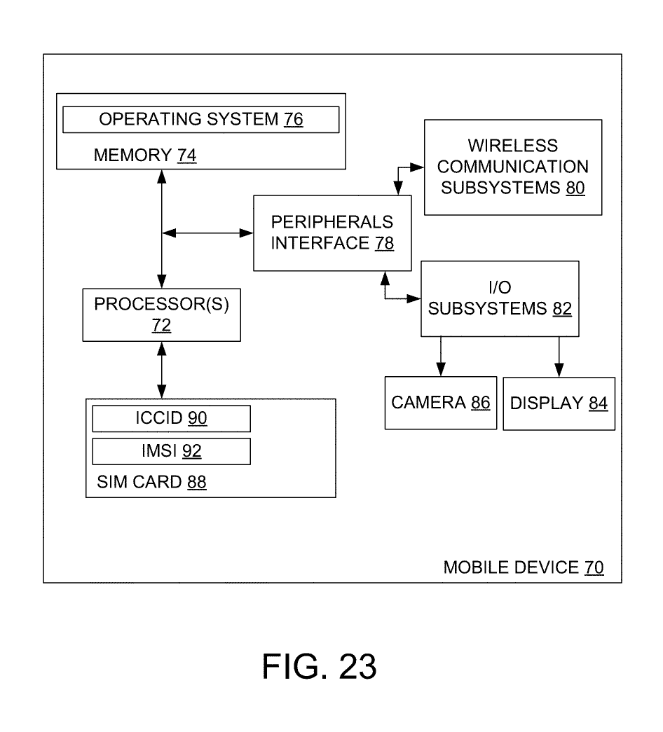

FIG. 23 illustrates a block diagram of an exemplary mobile device 70. Mobile device 70 includes one or more processors 72, such as a central processing unit or image processors, and a memory 74. Processor(s) 72 and memory 74 are connected by one or more signal lines or buses. Memory 74 can take the form of any processor-readable medium including a disk or solid-state memory, for example. Memory 74 includes an operating system 76 that includes instructions for handling basic system services and performing hardware-dependent tasks. In some implementations, operating system 76 can be a kernel. Memory 74 also includes various instructions representing applications that can be executed by processor(s) 172 including communication instructions that allow processor 72 to communicate through peripherals interface 78 and wireless communication subsystems 80 to a wireless cellular telephony network and/or a wireless packet switched network and/or a local area network using a wireless communication standard.

Peripherals interface 78 provides access between processor(s) 72 and one or more input/output subsystems 82. I/O subsystems 82 control input and output for mobile device 70. I/O subsystems 82 can include touchscreen display 84, which can detect contact and movement or break thereof using any of a plurality of touch sensitivity technologies including, but not limited to capacitive, resistive, infrared and surface acoustic wave technologies as well as other proximity sensor arrays or other elements for determining one or more points of contact with display 84. I/O subsystems 82 can also include a camera 86. Other inputs can also be provided such as one or more buttons, rocker switches, thumb wheel, infrared port, USB port and/or pointer device such as a stylus.

Mobile device 70 can also include a subscriber identity module, which in many embodiments takes the form of a SIM card 88. SIM card 88 stores an ICCID 90 and an IMSI 92. ICCID 90 is the Integrated Circuit Card Identifier, which uniquely identifies this card on all networks. IMSI 192 is the international mobile subscriber identity, which identifies the SIM card on an individual cellular network. When communicating through wireless communication subsystems 80, processor(s) 72 can use identifiers 90 and/or 92 to uniquely identify mobile device 70 during communications. In accordance with many embodiments, SIM card 88 is removable from mobile device 70 and may be inserted in other devices.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A networked system comprising:
a plurality of devices that access user portals;
a plurality of digital displays located in a retail store alongside retail or product displays, each digital display displays content related to the retail or product displays, includes sensors and a camera and is configured to create user sessions with date and time stamps based on each camera detecting an anonymous customer's face; and
a real-time data store and processor, wherein the processor is configured to analyze data collected from the sensors of each digital display during each user session to determine real-time in-store customer insight data related to in-store customer behavior and configured to relay the insight data to the user portals accessed by the plurality of devices.

2. The networked system of claim 1, wherein the digital displays are further configured to end each user session with a date and time stamp by determining if a threshold of time has passed since the camera last detected an anonymous customer's face.

3. The networked system of claim 1, wherein the plurality of devices comprise a plurality of vendor devices.

4. The networked system of claim 3, wherein the processor is further configured to receive vendor digital content from the plurality of vendor devices through the user portals and is further configured to deploy the vendor digital content to the plurality of digital displays.

5. The networked system of claim 1, wherein the plurality of devices comprise a plurality of team member devices that access team member user portals.

6. The networked system of claim 5, wherein the team member user portals include comment submission forms configured to receive comments related to real-time customer interaction with team members regarding the retail or product displays, wherein the comments are deployed in real-time with the insight data.

7. The networked system of claim 1, further comprising a plurality of buyer devices that access buyer dashboards configured to receive the real-time insight data.

8. The networked system of claim 1, wherein the insight data comprises traffic data that includes a count of user sessions that relate to a count of customers that dwell at the retail or product displays.

9. The networked system of claim 1, wherein the insight data comprises engagement data that includes a count of user sessions where the digital displays located alongside the retail or product displays are touched or swiped.

10. The networked system of claim 1, wherein the insight data comprises sales data accessed from internal retail store data.

11. A method of managing digital content in a retail store, the method comprising:
deploying digital content to digital displays positioned alongside retail or product displays in a retail store, each digital display including sensors and a camera and configured to create user sessions with date and time stamps indicative of a customer interfacing with one of the digital displays and based on each camera detecting an anonymous customer's face;
collecting and analyzing data during each user session from the sensors and the cameras located on the digital displays;
determining real-time in-store customer insight data from the analyzed data; and
sending the insight data to a plurality user portals accessible by a plurality of devices.

12. The method of claim 11, wherein the digital displays are further configured to end user sessions with date and time stamps by determining if a threshold of time has passed since the camera last captured an anonymous customer's face.

13. The method of claim 11, wherein the plurality of devices comprise a plurality of vendor devices, wherein the deployed digital content comprises vendor digital content received from the plurality of vendor devices.

14. The method of claim 11, wherein the plurality of devices comprise a plurality of team member devices.

15. The method of claim 15, further comprising receiving comments from the plurality of team member devices and deploying the received comments from the plurality of team member devices in real-time with the insight data, wherein the comments are related to real-time customer interaction with team members regarding the retail or product displays and

16. The method of claim 11, wherein the plurality of devices comprise a plurality of buyer devices.

17. A method of managing digital content in a retail store, the method comprising:
receiving vendor digital content from a plurality of vendor devices;
deploying the vendor digital content to digital displays positioned alongside retail or product displays in a retail store, each digital display including sensors and a camera and configured to create user sessions with date and time stamps indicative of a customer interfacing with one of the digital displays;
collecting and analyzing data during each user session from the sensors and cameras located on the digital displays that relate to the retail or product displays;
determining real-time in-store customer insight data from the analyzed data; and
sending the insight data to the plurality of vendor devices.

18. The method of claim 17, wherein the digital displays are further configured to create the user sessions based on each camera detecting an anonymous customer's face.

19. The method of claim 18, wherein the digital displays are further configured to end the user sessions with date and time stamps by determining if a threshold of time has passed since the camera last detected an anonymous customer's face.

20. The method of claim 17, wherein determining the insight data comprises:
determining traffic data that includes a count of user sessions that relate to a count of customers that dwell at the retail or product displays;
determining engagement data that includes a count of user sessions where the digital displays located alongside the retail or product displays are touched or swiped; and
determining sales data by accessing internal retail store data through a store server.
